(19) United States
(12) Patent Application Publication
(10) Pub. No.: US 2011/0281998 A1
(43) Pub. Date: Nov. 17, 2011

(54) POLYURETHANE-POLYUREA DISPERSIONS BASED ON POLYCARBONATE-POLYOLS

(75) Inventors: Lyubov Gindin, Pittsburgh, PA (US); Peter Schmitt, Beaver, PA (US); Ronald Konitsney, Midland, PA (US); William Corso, Coraopolis, PA (US); Thorsten Rische, Columbus, GA (US); Thomas Feller, Soligen (DE); Thomas Michaelis, Leverkusen (DE)

(73) Assignees: BAYER MATERIALSCIENCE AG, LEVERKUSEN (DE); BAYER MATERIAL SCIENCE LLC, PITTSBURGH, PA (US)

(21) Appl. No.: 12/994,584

(22) PCT Filed: May 27, 2009
(86) PCT No.: PCT/US09/03239

§ 371 Date: Jan. 31, 2011

Related U.S. Application Data
(60) Provisional application No. 61/130,468, filed on May 30, 2008.

(51) Int. Cl. C09D 175/06; F16J 15/32; D04H 3/04; C09D 175/12

(52) U.S. Cl. 524/537; 524/591; 69/21; 28/100

(57) ABSTRACT

The invention relates to new, hydrolysis-stable, aqueous polyurethane-polyurea dispersions based on polycarbonate-polyols, to a process for preparing them and to their use in coating materials.

### BACKGROUND OF THE INVENTION

The invention relates to new, hydrolysis-stable, aqueous polyurethane-polyurea dispersions based on polyether-polycarbonate-polyols, to a process for preparing them and to their use in coating materials.

Substrates are increasingly being coated using aqueous binders, especially polyurethane-polyurea (PU) dispersions. The preparation of aqueous PU dispersions is known to those skilled in the art.

In the coating of flexible substrates, in particular textile and leather, solvent containing systems are increasingly replaced by low-solvent or solvent free aqueous systems The polyurethane dispersions largely fulfill the requirements of textile and leather coatings, such as high resistance to chemicals, high mechanical resistance and high tensile strength and flexibility.

An objective of present invention is to provide a novel PU dispersions as coating compositions for flexible substrates, which not only meet the requirements of PU dispersions described above but also display excellent thermal stability, hydrolytic stability and color retention.

It has been found that ionic/or non-ionic hydrophilic, aqueous polyurethane-polyurea dispersions (PUDs) based on polycarbonate polyols allow coatings with the range of properties mentioned above to be produced on substrates. The coatings according to this invention display improved hydrolysis resistance, thermal stability and excellent color retention under increased temperature for a long period of time.

### SUMMARY OF THE INVENTION

The present invention accordingly provides aqueous polyurethane-polyurea dispersions comprising the synthesis components:
I.1) one or more polyisocyanates,
II.2) one or more polycarbonate polyols having number-average molecular weights of 1000 to 3000 g/mol, having a hydroxyl number of 18 to 56 mg KOH/g, and an OH functionality of 1.8 to 2.2,
I.3) one or more compounds having a molecular weight of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds, and
I.6) optionally one or more isocyanate-reactive, nonionically hydrophilicizing compounds,
   wherein the polyol component I.2) contains 60% to 100% by weight of polytetramethylene glycol-based polycarbonate polyols, based on the total amount of component I.2); and with the proviso that the polycarbonate polyol is not based on polytetramethylene glycol polyols.

The present invention also provides a process for preparing the aqueous polyurethane-polyurea dispersions of the invention, comprising

a) reacting:
I.1) one or more polyisocyanates,
I.2) one or more polycarbonate polyols having number-average molecular weights of 1000 to 3000 g/mol, having a hydroxyl number of 18 to 56 mg KOH/g, and an OH functionality of 1.8 to 2.2,
I.3) one or more compounds having a molecular weight of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds, and
I.6) optionally one or more isocyanate-reactive, nonionically hydrophilicizing compounds
   such that an isocyanate-functional prepolymer free of urea groups is prepared, the molar ratio of isocyanate groups to isocyanate-reactive groups being 1.0 to 3.5
   b) dispersing the reaction products in water; and
   c) before, during or after dispersing in water, subjecting the remaining isocyanate groups to amino-functional chain extension or chain termination, wherein the equivalent ratio of isocyanate-reactive groups of the compounds used for chain extension to free isocyanates groups of the prepolymer is between 40% to 150%.

### DETAILED DESCRIPTION OF THE PREFERRED EMBODIMENTS

Unless otherwise indicated, all references in the specification and the claims to “molecular weight” are to number-average molecular weight.

Suitable polyisocyanates of component I.1) are the aromatic, araliphatic, aliphatic or cycloaliphatic polyisocyanates which are known in the art. They can be used individually or in any desired mixtures with one another.

Examples of suitable polyisocyanates are butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)-methanes or their mixtures with any desired isomer content, cyclohexylene 1,4-diisocyanate, phenylene 1,4-diisocyanate, tolylene 2,4- and/or 2,6-diisocyanate, naphthylene 1,5-diisocyanate, diphenylmethane 2,4′- or 4,4′-diisocyanate, 1,3- and 1,4-bis(2-isocyanatoprop-2-yl)benzene (TMXDI) and 1,3-bis(isocyanatomethyl)benzene (XDI). Proportionally it is also possible to use polyisocyanates having a functionality ≧2. These include modified diisocyanates with a uretdione, isocyanurate, urethane, allophanate, biuret, iminooxadiazinedione and/or oxadiazinetrione structure, and also unmodified polyisocyanate having more than 2 NCO groups per molecule, for example 4-isocyanatomethyloctane 1,8-diisocyanate (nonane triisocyanate) or triphenylmethane 4,4′,4″-triisocyanate.

The polyisocyanates or polyisocyanate mixtures in question are preferably those of the aforementioned kind containing exclusively aliphatically and/or cycloaliphatically attached isocyanate groups, with an average functionality of 2 to 4, preferably 2 to 2.6 and more preferably 2 to 2.4.

Particular preference is given to hexamethylene diisocyanate, isophorone diisocyanate, the isomeric bis(4,4′-isocyanatocyclohexyl)methanes, and mixtures thereof.

Suitable polycarbonates I.2) can be obtained by reaction of carbon acid derivatives, e.g. diphenyl carbonate, dimethyl carbonate or phosgene with diols. Suitable examples of such diols include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-pro-panediol, 2,2,4-trimethyl pentanediol-1,3, dipropylene glycol, polypropylene glycols, dibutylene glycol, polybutylene glycols, bisphenol A, tetrabromobisphenol A as well as lactone-modified diols. The diol component preferably contains 40 to 100 wt. % hexanediol, preferably 1,6-hexanediol and/or hexanediol derivatives. More preferably the diol component includes examples that in addition to terminal OH groups display ether or ester groups.

The hydroxyl polycarbonates should be substantially linear. However, they can optionally be slightly branched by the incorporation of polyfunctional components, in particular low-molecular polyols. Suitable examples include glycerol, trimethylol propane, hexanetriol-1,2,6, butanetriol-1,2,4, trimethylol propane, pentaerythritol, quinitol, mannitol, and sorbitol, methyl glycoside, 1,3,4,6-dianhydrohexites.

The low molecular weight polyols I.3) used for synthesizing the polyurethane resins generally have the effect of stiffening and/or of branching the polymer chain. The molecular weight is preferably between 62 and 299 g/mol. Suitable polyols I.3) may contain aliphatic, alicyclic or aromatic groups. Mention may be made here, by way of example, of the low molecular weight polyols having up to about 20 carbon atoms per molecule, such as ethylene glycol, diethylenc glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxy-phenyl)propane), hydrogenated bisphenol A (2,2-bis(4-hydroxycyclohexyl)-propane), and also trimethylolpropane, glycerol or pentaerythritol, and mixtures of these and optionally also further low molecular weight polyols I.3). Esterdiols as well, such as α-hydroxybutyl-ε-hydroxycaproic esters, ω-hydroxyhexyl-γ-hydroxybutyric esters, adipic acid β-hydroxyethyl esters or terephthalic acid bis(β-hydroxyethyl) esters, can be used. Preferred synthesis components ii) are 1,2-ethanediol, 1,4-butanediol, 1,6-hexanediol and 2,2-dimethylpropane-1,3-diol. Particular preference is given to 1,4-butanediol and 1,6-hexanediol.

Diamines or polyamines and also hydrazides can likewise be used as I.3), examples being ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic dihydrazide.

Also suitable in principle as I.3) are compounds which contain active hydrogen having different reactivity towards NCO groups, such as compounds which contain both a primary amino group and secondary amino groups or as well as an amino group (primary or secondary) also contain OH groups. Examples of such are primary/secondary amines, such as 3-amino-1-methylaminopropane, 3-amino-1-ethylaminopropane, 3-amino-1-cyclohexylaminopropane, 3-amino-1-methylaminobutane, and also alkanolamines such as N-aminoethylethanolamine, ethanolamine, 3-aminopropanol, neopentanolamine and, with particular preference, diethanolamine. In the preparation of the PU dispersion of the invention they can be used as chain extenders and/or as chain termination.

The PU dispersions of the invention may also optionally contain units I.4) which are in each case located at the chain ends and close off the ends. These units are derived from monofunctional compounds reactive with NCO groups, such as monoamines, especially mono-secondary amines, or monoalcohols. Mention may be made here, by way of example, of ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)amino-propylamine, morpholine, piperidine, and/or suitable substituted derivatives thereof, amide amines formed from diprimary amines and monocarboxylic acids, monoketimes of diprimary amines, primary/tertiary amines, such as N,N-dimethyl-aminopropylamine, and the like.

By ionically or potentially ionically hydrophilicizing compounds I.5) are meant all compounds which contain at least one isocyanate-reactive group and also at least one functionality, such as —COOY, —SO₃Y, —PO(OY)₂ (Y, for example, ═H, NH₄⁺, metal cation), —NR₂, —NR₃⁺(R═H, alkyl, aryl), which on interaction with aqueous media, enters into a pH-dependent dissociation equilibrium and in that way may carry a negative, positive or neutral charge. Preferred isocyanate-reactive groups are hydroxyl or amino groups.

Suitable ionically or potentially ionically hydrophilicizing compounds corresponding to the definition of component I.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulphonic acid, ethylenediamine-propyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts; the adduct of sodium bisulphite with but-2-ene-1,4-diol, polycthersulphonate, the propoxylated adduct of 2-butenediol and NaHSO₃, described for example in DE-A 2 446 440 (page 5-9, formula I-III), and also compounds which contain units which can be converted into cationic groups, examples being amine-based units, such as N-methyldiethanolamine, as hydrophilic synthesis components. It is additionally possible to use cyclohexylaminopropanesulphonic acid (CAPS) as, for example, in WO-A 01/88006 as a compound corresponding to the definition of component I.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Suitable nonionically hydrophilicizing compounds corresponding to the definition of component I.6) are, for example, polyoxyalkylene ethers which contain at least one hydroxyl or amino group. These polyethers contain a fraction of 30% to 100% by weight of units derived from ethylene oxide.

Hydrophilic synthesis components I.6) for incorporating terminal hydrophilic chains containing ethylene oxide units are preferably compounds of the formula (I),

H—Y′—X—Y—R (I)

in which
R is a monovalent hydrocarbon radical having 1 to 12 carbon atoms, preferably an unsubstituted alkyl radical having 1 to 4 carbon atoms,
X is a polyalkylene oxide chain having 5 to 90, preferably 20 to 70 chain members, which may be composed to an extent of at least 40%, preferably at least 65%, of ethylene oxide units and which in addition to ethylene oxide units may be composed of propylene oxide, butylene oxide or styrene oxide units, preference among the last-mentioned units being given to propylene oxide units, and
Y/Y′ is oxygen or else is —NR′—, with R′ corresponding in its definition to R or hydrogen.

Particularly preferred synthesis components I.6) are the copolymers of ethylene oxide with propylene oxide, having an ethylene oxide mass fraction of greater than 50%, more preferably of 55% to 89%.

In one preferred embodiment use is made as synthesis components I.6) of compounds having a molecular weight of at least 400 g/mol, preferably of at least 500 g/mol and more preferably of 1200 to 4500 g/mol.

Preference is given to using 5% to 30% by weight of component I.1), 60% to 90% by weight of the sum of components I.2), 0.5 to 30% by weight of the sum of compounds I.3) and I.4), 0.1% to 5% by weight of component I.5), 0% to 10% by weight of component I.6), the sum of I.5) and I.6) being 0.1% to 15% by weight and the sum of all the components adding up to 100% by weight.

Particular preference is given to using 5% to 25% by weight of component I.1), 65% to 85% by weight of the sum of components I.2), 0.5 to 25% by weight of the sum of compounds I.3) and I.4), 0.1% to 4% by weight of component I.5), 0% to 10% by weight of component I.6), the sum of I.5) and I.6) being 0.1% to 14% by weight and the sum of all the components adding up to 100% by weight.

Very particular preference is given to using 13% to 20% by weight of component I.1), 65% to 80% by weight of the sum of components I.2), 0.5 to 14% by weight of the sum of compounds I.3) and I.4), 0.1% to 3.5% by weight of component I.5), 1% to 6% by weight of component I.6), the sum of I.5) and I.6) being 0.1% to 13.5% by weight and the sum of all the components adding up to 100% by weight.

The process for preparing the aqueous PU dispersion (I) can be carried out in one or more stages in a homogeneous phase or, in the case of multi-stage reaction, partially in disperse phase. Following polyaddition of I.1)-I.6), carried out completely or partially, there are dispersing, emulsifying or dissolving steps.

Thereafter, optionally, there is a further polyaddition or modification in disperse phase.

To prepare the aqueous PU dispersions of the invention it is possible to use all of the methods known in the art, such as the prepolymer mixing method, acetone method or melt dispersing method, for example. The PU dispersions of the invention are prepared preferably by the acetone method.

For preparing the PU dispersion (I) by the acetone method, the constituents I.2) to I.6), which should contain no primary or secondary amino groups, and the polyisocyanate component I.1) for preparing an isocyanate-functional polyurethane prepolymer, are usually introduced as an initial charge, in whole or in part, diluted optionally with a solvent which is miscible with water but inert towards isocyanate groups, and heated to temperatures in the range from 50 to 120° C. To accelerate the isocyanate addition'reaction it is possible to use the catalysts that are known in polyurethane chemistry. Preference is given to dibutyltin dilaurate.

Suitable solvents are the customary aliphatic, keto-functional solvents such as acetone or butanone, for example, which can be added not only at the beginning of the preparation but also, optionally, in portions later on. Acetone and butanone are preferred. Other solvents such as, for example, xylene, toluene, cyclohexane, butyl acetate, methoxypropyl acetate, N-methylpyrolidene solvents with ether units or ester units, may likewise be employed and distilled off in whole or in part, or may remain completely in the dispersion.

Subsequently any constituents from I.1)-I.6) that were not added at the beginning of the reaction are metered in.

With regard to the preparation of the polyurethane prepolymer, the molar ratio of isocyanate groups to isocyanate-reactive groups is 1.0 to 3.5, preferably 1.2 to 3.0, more preferably 1.3 to 2.5.

The reaction of components I.1)-I.6) to form the prepolymer takes place partially or completely, but preferably completely. In this way polyurethane prepolymers containing free isocyanate groups are obtained, in bulk (without solvent) or in solution.

The preparation of the polyurethane prepolymers is accompanied or followed, if it has not yet been carried out in the starting molecules, by the partial or complete formation of salts of the anionically and/or cationically dispersing groups.

In the case of anionic groups, use is made for this purpose of bases such as tertiary amines, examples being trialkylamines having 1 to 12, preferably 1 to 6, C atoms in each alkyl radical. Examples thereof are trimethylamine, triethylamine, methyldiethylamine, tripropylamine, N-methylmorpholine, methyldiisopropylamine, ethyldiisopropylamine and diisopropylethylamine. The alkyl radicals may also, for example, bear hydroxyl groups, as in the case of the dialkylmonoalkanolamines, alkyldialkanolamines and trialkanolamines. As neutralizing agents it is also possible optionally to use inorganic bases, such as ammonia or sodium hydroxide and/or potassium hydroxide. Preference is given to triethylamine, triethanolamine, dimethylethanolamine or diisopropylethylamine.

The molar amount of the bases is between 50% and 125%, preferably between 70% and 100%, of the molar amount of the anionic groups.

In the case of cationic groups, dimethyl sulphate or succinic acid or phosphoric acid are used. Neutralization may also take place simultaneously with dispersing, with the dispersing water already containing the neutralizing agent.

Subsequently, in a further process step, if it has not yet happened or has taken place only partially, the prepolymer obtained is dissolved using aliphatic ketones such as acetone or butanone.

Subsequently, possible NH₂-functional and/or NH-functional components are reacted with the remaining isocyanate groups. This chain extension/chain termination may be carried out either in solvent prior to dispersing, during dispersing, or in water after dispersing. Chain extension is preferably carried out prior to dispersing in water.

Where chain extension is carried out using compounds corresponding to the definition of I.5) with NH₂ groups or NH groups, the prepolymers are preferably chain-extended before the dispersing operation.

The degree of chain extension, in other words, 100% multiplied by the equivalent ratio of NCO-reactive groups of the compounds used for chain extension to free NCO groups of the prcpolymer, is between 40% to 150%, preferably between 50% to 120%, more preferably between 60% to 120%.

The aminic components [I.3), I.4), I.5)] may optionally be used in water- or solvent-diluted form in the process of the invention, individually or in mixtures, with any sequence of addition being possible.

If water or organic solvents are used as diluents, the diluent content is preferably 70% to 95% by weight.

The preparation of the PU dispersion from the prepolymers takes place following chain extension. For that purpose the dissolved and chain-extended polyurethane polymer either is introduced into the dispersing water with strong shearing, such as vigorous stirring, for example, or, conversely, the dispersing water is stirred into the prepolymer solutions. Preferably the water is introduced into the dissolved prepolymer.

The solvent still present in the dispersions after the dispersing step is usually subsequently removed by distillation. Its removal during dispersing is also a possibility.

The solids content of the PU dispersion is between 20% to 70%, preferably 30% to 65% by weight.

The PU dispersions of the invention may comprise antioxidants and/or light stabilizers and/or other auxiliaries and additives such as, for example, emulsifiers, defoamers, thickeners. Finally it is also possible for fillers, plasticizers, pigments, carbon-black sols and silica sols, aluminium dispersions, clay dispersions and asbestos dispersions, flow control agents or thixotropic agents to be present. Depending on the desired pattern of properties and intended use of the PU dispersions of the invention it is possible for up to 70%, based on total dry-matter content, of such fillers to be present in the end product.

The present invention also provides coating materials comprising the polyurethane-polyurea dispersions of the invention.

Further provided by the present invention is the use of the polyurethane-polyurea dispersions of the invention as coating materials for producing coated substrates.

The polyurethane-polyurea dispersions of the invention are likewise suitable for producing size systems or adhesive systems.

Examples of suitable substrates include woven and non-woven textiles, leather, paper, hard fibre, straw, paper-like materials, wood, glass, plastics of any of a very wide variety of kinds, ceramic, stone, concrete, bitumen, porcelain, metals or glass fibres or carbon fibres. Preferred substrates are, in particular, flexible substrates such as textiles, leather, plastics, metallic substrates and glass fibres or carbon fibres, and particular preference is given to textiles and leather.

The present invention also provides substrates coated with coating materials comprising the polyurethane-polyurea dispersions of the invention.

The PU dispersions of the invention are stable, storable and transportable and can be processed at any desired subsequent point in time. They can be cured at relatively low temperatures of 120 to 150° C. within 2 to 3 minutes to give coatings which have, in particular, very good wet bond strengths.

On account of their excellent stretchability in conjunction with extremely high tensile strengths, the PU dispersions of the invention are particularly suitable for applications in the field of textile coating and leather coating even under hydrolysis conditions.

### EXAMPLES

### Starting Materials Used

| Name of the raw | |
|---|---|
| material | Description of the raw material |
| Desmophen C-2200 | Polycarbonate diol based on 1,6-hexanediol, |
| (Bayer AG) | OH number is 56, molecular weight 2000 g/mol |
| Polyether LB 25 | Monofunctional polyethylene glycol, OH number |
| (Bayer AG) | 25, molecular weight 2250 g/mol |
| Desmodur I | 3-isocyanatomethyl-3,5,5-trimethylcyclohexyl |
| (Bayer USA) | isocyanate, NCO content 37.8%, molecular weight |
| | 222 g/mol |
| Desmodur H | 1,6-Hexamethylene Diisocyanate, NCO content |
| (Bayer USA) | 50%, molecular weight 168 |
| Baybond VP LS | Diaminosulfonate, 45% in water, amine number |
| 2387 (Bayer AG) | 266, molecular weight 422 |
| Hydrazine Hydrate | 64% in water, molecular weight 50 as supplied |
| (Bayer AG) | |
| IPDA (Aldrich) | 3-aminomethyl-3.5,5-trimethylcyclohexyl amine, |
| | molecular weight 170.3 as supplied |
| Irganox 1010 (Ciba) | Phenolic based anti-oxidant |
| Tinuvin 765 (Ciba) | Light stabilizer |

### Example 1

The mixture of 279.2 g of Desmophen C-2200 and 14.9 g of Polyether LB 25 was combined with 35.6 g of Desmodur 1 and 26.9 g of Desmodur H at 70 C, heated to 105 C and stirred at 105 C until a constant NCO value of 4.13% (theoretical value is 4.18%) was achieved. The prepolymer was dissolved with 631.7 g of acetone at 105 C and stirred for 20 minutes. A mixture of 1.1 g of Hydrazine Hydrate, 6.8 g of diaminosulfonate and 25 g of water was added at 42 C over 6 minutes and stirred for 10 minutes. A mixture of 12.7 g of IPDA and 63.6 g of water was added at 40 C within 15 minutes and stirred for 10 minutes. 278.6 g of water was added at 40 C within 15 minutes and mixed for 5 minutes before addition of 2.8 g of Irganox 1010 and 2.8 g of Tinuvin 765. The mixture was mixed for 10 minutes before acetone was distilled. The final dispersion was filtered through 50 micron filter.

A dispersion with a solid content of 52.8% (Mettler moisture Analyzer HR 73, method 14-007), viscosity of 120 cps at 23 C (Brookfield model RVT, spindle #3, 100 rpm, method 15-003), pH of 7.6 (Fisher model AB-15, method 14-003), and mean particle size of 0.604 micron (Horiba particle size Analyzer model LA-910, method 04-003) was obtained.

### Comparative Example 1

Anionic aliphatic C4 polyether polycarbonate polyurethane dispersion with a solid content of 60% and the following physical properties: modulus at 100%=350 psi, tensile strength=3500 psi, viscosity at 23 C (4 mm cup according to AFAM 2008/105,0304-00 D method)<90 sec, such as Impranil DLU (Bayer AG, Leverkusen).

### Comparative Example 2

Anionic aliphatic polyester polyurethane dispersion with a solid content of 40% and the following physical properties: modulus at 100%=300 psi, tensile strength=2900 psi, viscosity at 23 C (4 mm cup according to AFAM 2008/105,0304-00 D method)<70 sec, such as Impranil DLN (Bayer AG, Leverkusen).

### Physical Testing

| | | | DLU | DLN |
|---|---|---|---|---|
| Properties | | Example 1 | LP500001 | LP70006 |
| Tensile | Initial | 5009 | 4070 | 2688 |
| Strength, psi | 1 wk HS | 6203 | 4070 | 408 |
| | 2 wk HS | 4992 | 3854 | 192 |
| | 1 wk 125 C. | 3491 | 4535 | NA |
| Elongation, % | Initial | 351 | 482 | 648 |
| | 1 wk HS | 384 | 483 | 647 |
| | 2 wk HS | 366 | 485 | 92 |
| | 1 wk 125 C. | 508 | 544 | NA |
| 100% Modulus | Initial | 443 | 440 | 416 |
| | 1 wk HS | 478 | 440 | 248 |
| | 2 wk HS | 446 | 401 | NA |
| | 1 wk 125 C. | 300 | 370 | NA |
| Yellow Index | 1 wk | 7.5 | 59.9 | 27.1 |
| @ 125 C. | | | (3 days) | |

### CONCLUSION OF TESTING

Based on the results shown in the Table above, we can state that the dispersion based on 100% Polycarbonate demonstrate improved hydrolytic stability and color retention (on nylon type fabric) than commercially available dispersions, such as Impranil DLU and Impranil DLN. Impranil DLU, which is prepared using C4 polyether polycarbonate diols, demonstrates very good hydrolytic stability but poor color retention on nylon type fabric. Impranil DLN, which is prepared using a polyester diol, has poor hydrolytic stability and poor color retention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane-polyurea dispersion comprising the synthesis components:
I.1) one or more polyisocyanates,
I.2) one or more polycarbonate polyols having number-average molecular weights of 1000 to 3000 g/mol, having a hydroxyl number of 18 to 56 mg KOH/g, and an OH functionality of 1.8 to 2.2,
I.3) one or more compounds having molecular weights of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds, and
I.6) optionally one or more isocyanate-reactive, nonionically hydrophilicizing compounds,
wherein the dispersion contains 60% to 90% by weight of component I.2), based on the total weight of the synthesis components; and with the proviso that the polycarbonate polyol is not based on polytetramethylene glycol polyols.

2. An aqueous polyurethane-polyurea dispersion according to claim 1, comprising 5% to 40% by weight of component I.1), 60% to 90% by weight of the sum of components I.2), 0.5% to 20% by weight of the sum of compounds I.3) and I.4), 0.1% to 5% by weight of component I.5), and 0% to 20% by weight of component I.6),wherein the sum of 1.5 and I.6) is between 0.1% to 25% by weight and the sum of all the components add up to 100% by weight.

3. A process for preparing the aqueous polyurethane-polyurea dispersion according to claim 1, comprising:
a) reacting:
I.1) one or more polyisocyanates,
I.2) one or more polycarbonate polyols having number-average molecular weights of 1000 to 3000 g/mol, having a hydroxyl number of 18 to 56 mg KOH/g, and an OH functionality of 1.8 to 2.2,
I.3) one or more compounds having molecular weights of 62 to 400 g/mol and possessing in total two or more hydroxyl and/or amino groups,
I.4) optionally one or more compounds possessing a hydroxyl or amino group,
I.5) one or more isocyanate-reactive, ionically or potentially ionically hydrophilicizing compounds,
I.6) optionally one or more isocyanate-reactive, nonionically hydrophilicizing compounds
such that an isocyanate-functional prepolymer free of urea groups is prepared, the molar ratio of isocyanate groups to isocyanate-reactive groups being 1.0 to 3.5
b) dispersing the reaction products in water; and
c) before, during or after dispersing in water, subjecting the remaining isocyanate groups to amino-functional chain extension or chain termination, wherein the equivalent ratio of isocyanate-reactive groups of the compounds used for chain extension to free isocyanates groups of the prepolymer is between 40% to 150%.

4. Coating materials comprising the polyurethane-polyurea dispersion according to claim 1.

5. A process for producing coated substrates comprising applying a coating material according to claim 4 to a substrate.

6. The process according to claim 5, wherein the substrate is selected from the group consisting of textiles and leather.

7. Substrates coated with coating materials according to claim 4.
